(19) United States
(12) Patent Application Publication
(10) Pub. No.: US 2021/0201087 A1
(43) Pub. Date: Jul. 1, 2021

(54) ERROR JUDGMENT APPARATUS, ERROR JUDGMENT METHOD AND PROGRAM

(71) Applicant: Nippon Telegraph and Telephone Corporation, Tokyo (JP)

(72) Inventor: Hidetoshi Kawaguchi, Musashino-shi, Tokyo (JP)

(21) Appl. No.: 17/265,867

(22) PCT Filed: Aug. 5, 2019
(86) PCT No.: PCT/JP2019/030729

§ 371 Date: Feb. 4, 2021

(30) Foreign Application Priority Data
Aug. 6, 2018 (JP) 2018-147838

(51) Int. Cl. G06K 9/62; G06N 3/08

(52) U.S. Cl. CPC G06K 9/6269; G06N 3/08; G06K 9/6262

(57) ABSTRACT

An error determination apparatus includes a classification estimation process observation unit configured to acquire data in an estimation process from a classification estimation unit for estimating a classification of classification object data and generate a feature vector based on the data, and an error determination unit configured to receive the feature vector generated by the classification estimation process observation unit and a classification result output from the classification estimation unit and determine whether the classification result is correct based on the feature vector and the classification result.

### TECHNICAL FIELD

The present disclosure relates to a technique for classifying intelligence. An example of the application area of the present technique is a technique with which security operators who handle security systems against cyber-attacks, such as Intrusion Prevention System (IPS) or antivirus software, automatically classify threat intelligence by machine learning and the like.

### BACKGROUND ART

The security operators handling security systems against cyber-attacks collect information regarding attackers, attackers' behaviors and tricks, vulnerabilities, and the like of cyber-attacks as threat intelligence. Because the threat intelligence needs to be generated daily, security operators need to continually and sequentially classify threat intelligence. Examples of threat intelligence include those described in Non Patent Literatures 1 and 2.

Known classification techniques include, for example, a technique for extracting, classifying, and evaluating patterns from vast data by machine learning (for example, Non-Patent literature 3). According to another known classification technique, based on a score of the class obtained by inputting information into a class classifier, it is determined whether the information is to be classified into a predetermined class (Patent Literature 1).

### CITATION LIST

### Patent Literature

Patent Literature 1: JP 2014-102555 A

### Non Patent Literature

Non Patent Literature 1: https://www.ipa.go.jp/security/vuln/STIX.html, searched on Aug. 2, 2018

Non Patent Literature 2: https://www.ipa.go.jp/security/vuln;TAXII.html, searched on Aug. 2, 2018

Non Patent Literature 3: http://scikit-learn.org/stable/, searched on Aug. 2, 2018

### SUMMARY OF THE INVENTION

### Technical Problem

As described above, the security operators need to classify threat intelligence, but there is a possibility that classification cannot be performed in the case where the number of threat intelligence itself becomes enormous. The inability to classify threat intelligence may lead to a failure to prevent cyber-attacks, Which is undesirable for an organization to be operated.

To evaluate all of the enormous threat intelligence, it is contemplated to generate patterns from pairs of threat intelligence and classification as learning data, configure a classification estimation module and automatically performing classification.

However, classification using the classification estimation module alone cannot avoid false classification. Threat intelligence needs to be handled in a sensitive manner, and after the security operators must determine whether classification is correct. In addition, although the technique described in Patent Literature 1 can determine whether class classification is correct, the accuracy is considered to be low.

In light of the foregoing, an object of the present disclosure is to provide a technique for accurately determining whether classification is correct in a technique for classifying intelligence.

### Means for Solving the Problem

The disclosed technique provides an error determination apparatus including a classification estimation process observation unit configured to acquire data in an estimation process from a classification estimation unit for estimating a classification of classification object data and generate a feature vector based on the data, and an error determination unit configured to receive the feature vector generated by the classification estimation process observation unit and a classification result output from the classification estimation unit and determine whether the classification result is correct based on the feature vector and the classification result.

### Effects of the Invention

According to the disclosed technique, it is possible to accurately determine whether the classification is correct in the technique for classifying intelligence.

### BRIEF DESCRIPTION OF DRAWINGS

FIG. 1 is a functional configuration view of a classifier 100 according to an embodiment of the present disclosure.

FIG. 2 is a view illustrating a hardware configuration example of the classifier 100.

FIG. 3 is a view for describing an operation example of a classification estimation process observation unit 121 (in the case of a neural network).

FIG. 4 is a view for describing an operation example of the classification estimation process observation unit 121 (in the case of a decision tree).

FIG. 5 is a view for describing an outline of operations of an error determination unit 122.

FIG. 6 is a flowchart illustrating a processing procedure for generating the error determination unit 122.

FIG. 7 is a view illustrating processing in S1.

FIG. 8 is a view illustrating processing in S2.

FIG. 9 is a view illustrating processing in S3.

FIG. 10 is a view illustrating processing in S4.

### DESCRIPTION OF EMBODIMENTS

Hereinafter, an embodiment of the present disclosure (present embodiment) will be described with reference to drawings. The embodiment described below is merely an example, and the embodiment to which the present disclosure is applied is not limited to the following embodiment

### Functional Configuration of Apparatus

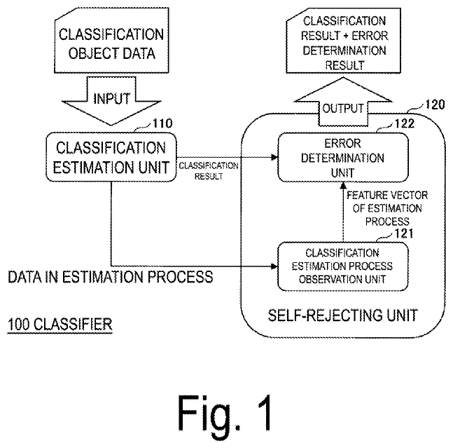

FIG. 1 is a functional configuration view of a classifier 100 according to an embodiment of the present disclosure. As illustrated in FIG. 1. the classifier 100 has a classification estimation unit 110 and a self-rejecting unit 120. The self-rejecting unit 120 includes a classification estimation process observation unit 121 and an error determination unit 122.

Note that the classification estimation unit 110 and the self-rejecting unit 120 may be constituted of separate devices, and may be connected to each other by a network, and in this case, the self-rejecting unit 120 may be referred to as a self-rejecting apparatus or an error determination apparatus. Also, an apparatus including the classification estimation unit 110 and the self-rejecting unit 120 may be referred to as a self-rejecting apparatus or an error determination apparatus. An outline of the operation of the classifier 100 is as follows.

### Operational Outline

First, classification object data is input to the classification estimation unit 110. The classification object data is data to be classified using the present system, for example, threat intelligence.

The classification estimation unit 110 estimates the classification of the input classification object data. The classification estimation unit 110 itself is a known art and can be implemented using artificial intelligence-related techniques such as SVM, neural networks. Bayesian networks, decision trees, and the like.

The classification estimation unit 110 outputs a classification result of the classification object data. The classification result is one or more “classification” in the predetermined classification list or “unknown”, The “unknown” is a result in the case where the classification estimation unit 110 can estimate the classification, but the classification result is doubtful due to low accuracy.

The classification estimation process observation unit 121 observes a calculation process in estimating the classification of the classification object data by the classification estimation unit 110, acquires data in an estimation process, converts the data into a feature vector, and outputs the feature vector to the error determination unit 122.

The error determination unit 122 receives observation data in the estimation process as the feature vector from the classification estimation process observation unit 121, and determines whether the classification estimated by the classification estimation unit 110 is “correct” or “incorrect” based on the observation data. In the case of “correct”, the classification estimated by the classification estimation unit 110 is used as the classification result, and in the case of “incorrect”, “unknown” is used as the classification result.

Details of the classification estimation process observation unit 121 and the error determination unit 122 will be described below.

### Example of Hardware Configuration

The classifier 100 described above (as well as the self-rejecting apparatus and the error determination apparatus) can be implemented by causing a computer to execute a program describing processing contents described in the embodiment.

In other words, the classifier 100 can be implemented by causing hardware resources such as a CPU and a memory incorporated in the computer to execute a program corresponding to the processing carried out by the classifier 100. The aforementioned program can be recorded, saved, and distributed in a computer-readable recording medium (portable memory or the like). In addition, the aforementioned program can also be provided through a network such as the Internet, an e-mail, or the like.

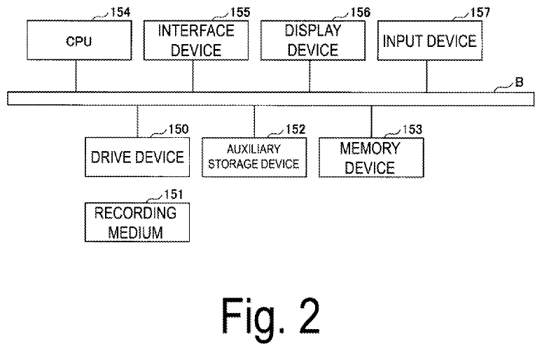

FIG. 2 is a view illustrating a hardware configuration example of the above-mentioned computer according to the present embodiment. The computer in FIG. 2 has a drive device 150, an auxiliary storage device 152, a memory device 153, a CPU 154, an interface device 155, a display device 156, and an input device 157, which are connected to each other via a bus B,

A program for implementing the processing in the computer is provided from a recording medium 151 such as a CD-ROM. When the recording medium 151 storing the program is set in the drive device 150, then the program is installed in the auxiliary storage device 152 from the recording medium 151 via the drive device 150. However, the program is not necessarily installed from the recording medium 151 and may be downloaded from another computer via a network. The auxiliary storage device 152 stores the installed program and also stores required files, data, and the like.

The memory device 153 reads and stores the program from the auxiliary storage device 152 in a case in which a command for activating the program is issued. The CPU 154 performs functions related to the classifier 100 in accordance with the program stored in the memory device 153. The interface device 155 is used as an interface for connecting to the network. The display device 156 displays a Graphical User Interface (GUI) or the like based on the program. The input device 157 is configured of a keyboard and a mouse, a button, a touch panel, or the like, and is used to allow for inputs of various operation commands,

### Details of Classification Estimation Process Observation Unit 121

The classification estimation process observation unit 121 observes the calculation process in estimating the classification of the classification object data by the classification estimation unit 110, and configures the feature vector. A specific example of the calculation process in estimating the classification of the classification object data, which is a target to be observed by the classification estimation process observation unit 121, is described using a neural network, a decision tree, and a random forest.

When the classification estimation unit 110 estimates the classification using the neural network, the classification estimation process observation unit 121 can use values output from nodes (activation functions) of each intermediate layer and output layer in the neural network as observation data in the calculation process.

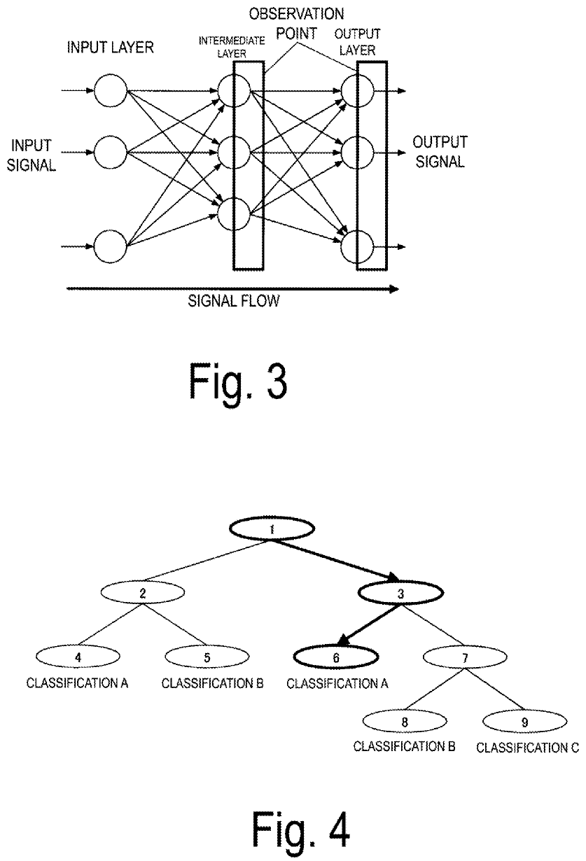

FIG. 3 illustrates an example of a three-layer neural network. In this example, values output from nodes (activation functions) in one intermediate layer and one output layer may he used as the observation data in the calculation process. The three layers as illustrated in FIG. 3 is merely an example, and four or more layers are essentially the same except that data to be observed increases. Note that the shape of the neural network in FIG. 3 is based on what is disclosed in “http://ipr20.cs.ehime-u.ac.jp/column/neural/chapter5.html”.

In the example illustrated in FIG. 3, the classification estimation process observation unit 121 acquires the values output from each node (activation function) at an observation point, and configures the feature vector. For example, when values of the nodes in the intermediate layer are 0.5, 0.4, 0.7 and values of the nodes in the output layer are 0.2, 0.7, 0.1, the feature vector may be configured as [0.5 0.4 0.7 0.2 0.7 0.1].

When the classification estimation unit 110 estimates the classification using the decision tree, the classification estimation process observation unit 121 observes a route to determine the classification and configures the feature vector. FIG. 4 illustrates an example of the decision tree. The decision tree in FIG. 4 is a decision tree that estimates one of three classifications: classification A, classification B, and classification C.

In the example illustrated in FIG. 4, when classification A is reached in a route of node 1 node 3 -> node 6, the classification estimation process observation unit 121 acquiring the observation data configures a feature vector [1 0 1 0 0 1 0 0 0]. In this example, the index of the vector element corresponds to the node number of the decision tree. The feature vector is configured such that when the route passes through a node, 1 enters the element corresponding to the node, and when the route does not pass through the node, 0 enters the element corresponding to the node.

Next, the case where the classification estimation unit 110 estimates the classification using a random forest will be described. The random forest is a model that creates a plurality of small decision trees and perform classification by decision of majority. As such, the feature vector can be configured by generating elements of the feature vector of small decision trees by the above-mentioned method of configuring the feature vector of the decision tree, and coupling the elements, Additionally, the number of votes of each classification may be coupled to the feature vector.

### Details of Error Determination Unit 122

The error determination unit 122 receives the estimated classification from the classification estimation unit 110. Additionally, the error determination unit 122 receives the feature vector of the observation data in the estimation process from the classification estimation process observation unit 121, and determines whether the classification estimated by the classification estimation unit 110 is “correct” or “incorrect” based on the observation data. In the case of “correct”, the classification estimated by the classification estimation unit 110 is used as the classification result, and in the case of “incorrect”, “unknown” is used as the classification result.

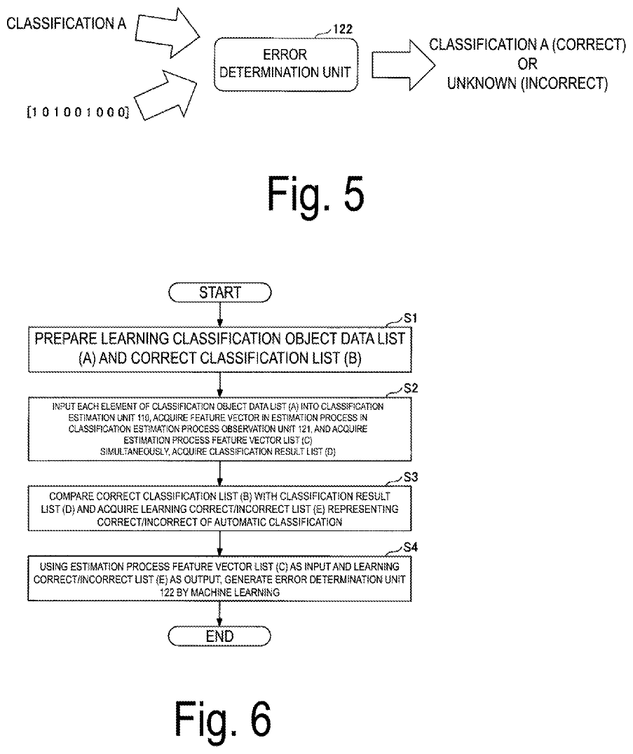

FIG. 5 illustrates a specific example. In the example in FIG. 5, the error determination unit 122 receives the classification A and a feature vector [1 0 1 0 0 1 0 0 0] from the classification estimation unit 110 and the classification estimation process observation unit 121 respectively, and determines whether the classification A is correct based on the classification A and the feature vector.

The method of configuring the error determination unit 122 is not limited to a specific method. For example, the error determination unit 122 may determine whether the classification is “correct” or “incorrect” by determining whether a particular value of the feature vector (in particular, the value of the output layer in the neural network and the number of votes in the random forest) exceeds a threshold.

Furthermore, the error determination unit 122 may be configured of a model often used in the machine learning field. The error determination unit 122 may be configured of the SVM or the neural network, for example. In using these models, the error determination unit 122 may be implemented by parameter-tuning the models by supervised learning. A method of creating the error determination unit 122 by machine learning will be described below.

### Method of Creating Error Determination Unit 122 by Machine Learning

FIG. 6 is a flowchart illustrating a procedure of a method of creating the error determination unit 122 by machine learning. Each step will be described below according to the procedure from S1 (step 1) to S4 (step 4) illustrated in FIG. 6.

Note that the processing of creating the error determination unit 122 may be executed by a learning unit provided in the classifier 100 (or the self-rejecting apparatus, the error determination apparatus) or may be executed by a learning unit provided in a computer separated from the classifier 100 (or the self-rejecting apparatus, the error determination apparatus). In addition, the entity of the created error determination unit 122 is software for calculating a mathematical formula corresponding to the parameter-tuned model.

### Step 1

In the step 1, learning classification object data list (A) and a correct classification list (B) thereof are prepared. In the case where the classification estimation unit 110 is tuned by machine learning, the learning data may also be diverted. Both of the learning classification object data list (A) and the correct classification list (B) thereof must be manually prepared.

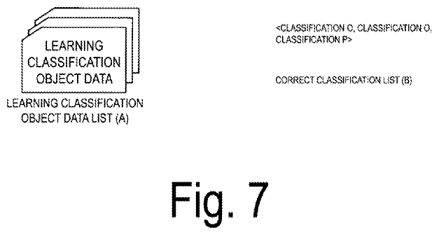

FIG. 7 illustrates an example of the learning classification object data list (A) and the correct classification list (B) thereof. In this example, the learning classification object data list (A) composed of three pieces of data and the correct classification list (B) corresponding to each pieces of data (in angle brackets < >) are illustrated.

### Step 2

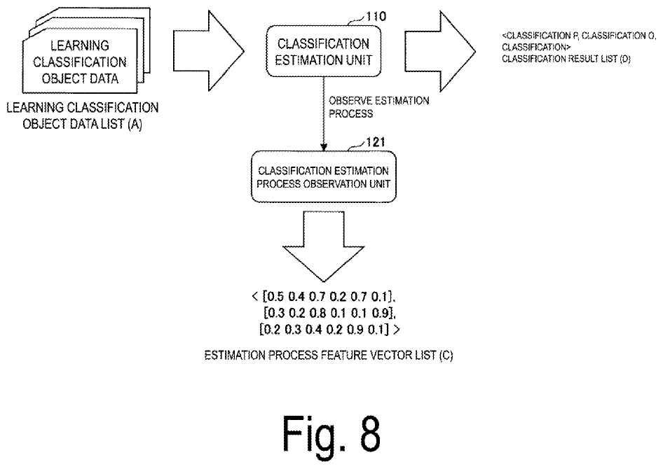

In the step 2, as illustrated in FIG. 8, each of the elements of the classification object data list (A) is input into the classification estimation unit 110. The classification estimation process observation unit 121 generates the feature vector of the estimation process in the above-described manner, and the learning unit acquires an estimation process feature vector list (C), which is the list of feature vectors. Simultaneously, the learning unit acquires a classification result list (D) from the classification estimation unit 110.

### Step 3

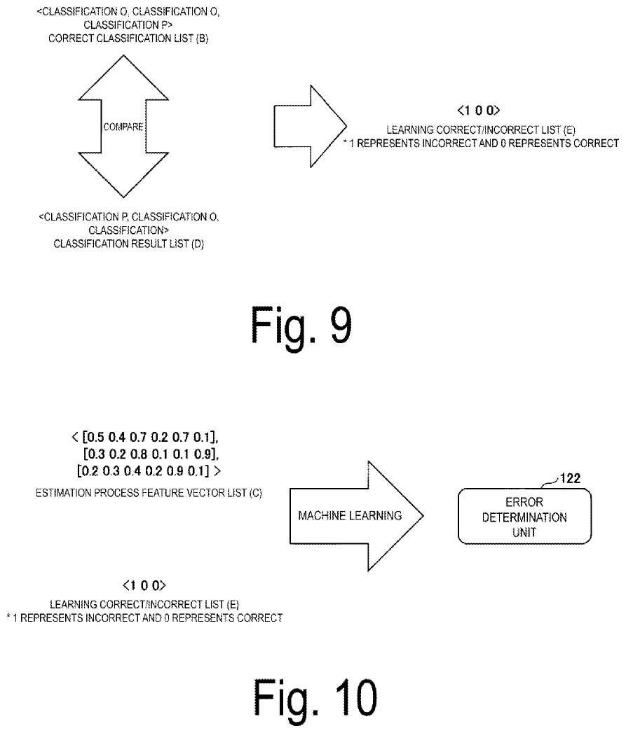

In the step 3, as illustrated in FIG. 9, the learning unit compares the correct classification list (B) with the classification result list (D), and acquires a learning correct/incorrect list (E) representing the correct/incorrect of automatic classification. In the example in FIG. 9, as described in the correct classification list (B), the correct classification of the first classification is a classification 0, while the first classification is a classification P in the classification result. Thus, the first classification is incorrect, and the first element of the learning correct/incorrect list (E) becomes 1 (incorrect). Because the second and third classifications are correct, the learning correct incorrect list (E) becomes <1 0 0>.

### Step 4

In the step 4, as illustrated in FIG. 10, for example, the learning unit performs machine learning using the estimation process feature vector list (C) as an input to the neural network (or SVM), and the learning correct incorrect list (E) as a correct output from the neural network (or SVM). As a result, the parameter-tuned neural network (or SVM) is acquired as the error determination unit 122.

Effects of Embodiment As described above, according to the technique according to the present embodiment, accurate determination can be made by observing the estimation process at the estimation of the classification estimation unit 110, and performing error determination based on the observation data

In addition, according to the technique according to the present embodiment, it is possible to distinguish the classification that is likely to be correct from the classification that is less likely to be correct. This facilitates that the classification that is likely to be correct is not manually checked, and the classification that is less likely to be correct may be manually checked.

### Summary of Embodiment

As described above, according to the present embodiment, the error determination apparatus including the classification estimation process observation unit and the error determination unit is provided. The classification estimation process observation unit acquires data in the estimation process from the classification estimation unit that estimates the classification of the classification object data, and generates the feature vector based on the data. The error determination apparatus receives the feature vector generated by the classification estimation process observation unit and the classification result output from the classification estimation unit, and determines whether the classification result is correct based on the feature vector and the classification result,

For example, the error determination unit outputs the classification result of the classification estimation unit when determining that the classification result is correct, and outputs information indicating that the classification is unknown when determining that the classification result is incorrect.

When the classification estimation unit is constituted of a neural network, the data in the estimation process may include output data from the node in the intermediate layer in the neural network, and when the classification estimation unit is constituted of a decision tree, the data in the estimation process may include information regarding the decision route in the decision tree.

The error determination unit may be a functional unit generated by machine learning based on the feature vector generated by the classification estimation process observation unit.

Although the embodiment has been described above, the present disclosure is not limited to such a specific embodiment, and various modifications and changes can be made within the scope of the gist of the present disclosure described in the aspects.

### REFERENCE SIGNS LIST

100 Classifier
110 Classification estimation unit
120 Self-rejecting unit
121 Classification estimation process observation unit
122 Error determination unit
150 Drive device
151 Recording medium
152 Auxiliary storage device
153 Memory device
154 CPU
155 Interface device
156 Display device
157 Input device

1. An error determination apparatus including one or more computers, comprising:
a classification estimation process observation unit configured to acquire, from a classification estimation unit, data in an estimation process to estimate a classification of classification object data and generate a feature vector based on the data; and
an error determination unit configured to receive the feature vector and a classification result output from the classification estimation unit and determine whether the classification result is correct based on the feature vector and the classification result.

2. The error determination apparatus according to claim 1, wherein:
the error determination unit is configured to output, based on determining that the classification result is correct, the classification result of the classification estimation unit and the error determination unit is configured to output, based on determining that the classification result is incorrect, information indicating that the classification is unknown.

3. The error determination apparatus according to claim 1, wherein:
based on the classification estimation unit being constituted of a neural network, the data in the estimation process includes output data from a node in an intermediate layer in the neural network, and
based on the classification estimation unit being constituted of a decision tree, the data in the estimation process includes information regarding a decision route in the decision tree.

4. The error determination apparatus according to claim 1, wherein the error determination unit is a functional unit generated by machine learning based on the feature vector.

5. An error determination method performed by a computer, the error determination method comprising:
acquiring data in an estimation process from a classification estimation unit for estimating a classification of classification object data and generating a feature vector based on the data;
receiving the feature vector and a classification result output from the classification estimation unit; and
determining whether the classification result is correct based on the feature vector and the classification result.

6. A recording medium storing a program, wherein execution of the program causes one or more computers of an error determination apparatus to perform operations comprising:
acquiring data in an estimation process from a classification estimation unit for estimating a classification of classification object data and generating a feature vector based on the data:
receiving the feature vector and a classification result output from the classification estimation unit and
determining whether the classification result is correct based on the feature vector and the classification result.

7. The recording medium according to claim 6, wherein the operations further comprise:
outputting, based on determining that the classification result is correct, the classification result of the classification estimation unit, and
outputting, based on determining that the classification result is incorrect, information indicating that the classification is unknown.

8. The recording medium according to claim 6, wherein the operations further comprise:
based on the classification estimation unit being constituted of a neural network, the data in the estimation process includes output data from a node in an intermediate layer in the neural network, and
based on the classification estimation unit being constituted of a decision tree, the data in the estimation process includes information regarding a decision route in the decision tree.
